(19) United States
(12) Patent Application Publication
(10) Pub. No.: US 2005/0219759 A1
(43) Pub. Date: Oct. 6, 2005

(54) System for minimizing cross-talk in storage devices

(75) Inventor: Maxim Roth, Cupertino, CA (US)

Correspondence Address: Sheldon R. Meyer;FLIESLER MEYER LLP, Four Embarcadero Center, Fourth Floor, San Francisco, CA, 94111-4156, US

(73) Assignee: Matsushita Electric Industrial Co., Ltd., Osaka (JP)

(21) Appl. No.: 10/812,522

(22) Filed: Mar. 30, 2004

(51) Int. Cl. G11B 5/48

(52) U.S. Cl. 360/246

(57) ABSTRACT

A storage device is configured to read and write data from one or more storage media. The storage device includes an actuator which reads and writes data. The actuator includes two or more read leads that connect to a pre-amp and run parallel to a write lead. The read leads are configured such that they cross at the middle, thus mostly canceling out the differences in induced voltage between the two read leads and reducing cross-talk.

### FIELD OF THE INVENTION

The present invention relates generally to configuring storage devices and more particularly to methods and systems for reducing cross-talk in the actuators of storage devices.

### BACKGROUND OF THE INVENTION

Over the past fifteen years, the storage demands of software applications and media have increased exponentially, creating a need and a market for storage devices with greater storage capacity. In order to accommodate these size demands, manufacturing techniques in storage devices have improved and hard drives have been designed with smaller and more closely bound form factors. Additionally, to accommodate the larger amounts of data being stored, there has been a need to vastly increase read and write capacities. While these changes have been beneficial in improving the storage capacity and performance of hard drives, they created engineering issues that were previously not of concern.

Specifically, the smaller form factors and increased transmission speeds have generated significant cross-talk between the write leads and read leads. What is needed is a method of organizing the leads that reduces cross-talk between the read leads.

FIG. 1 illustrates a prior art embodiment of read and write lines for a storage device. A first 105 and second 110 read leads receive read signals drawn from the surface of a storage medium of a hard drive. The two leads 105, 110, transmit the read signals to a pre-amp, which amplifies the read signals before transmitting them to a read channel. The traces are preferably bound to a read stripe which loosely connects them.

A write lead 115 transmits write signals which are used to imprint data on the storage medium of the hard drive. The write lead is located distance D1 away from the second lead 110 and D2 away from the first lead 110.

As indicated by the Biot-Savart law, current flowing through a wire generates a magnetic field proportional to the magnitude of the current. When the current changes, this produces a changing magnetic field. When magnetic fields change, this induces a voltage in the region of the changing magnetic field, proportional to the rate of change of the current and the mutual inductance between the “aggressor”, which in this case is the write lead 115 and the “victim” lead, which is either of the read leads 105, 110. As write speeds for storage devices have gone up over the years, the rate of change of the current in the write leads has increased significantly, allowing for nontrivial voltages to be induced in the read leads.

The mutual inductance between the aggressor and the victim lead is inversely proportional to the distance between the victim and the aggressor. Since the write wire has differing distances D1 and D2 between the second read lead 110 and the first read lead 105 respectively, different voltages are induced in each lead. The difference in voltages causes current to travel across the read stripe between the first and second leads 105, 110. As the read leads are placed closer and closer to the write lead 115, the induced voltages become larger and the distance between the two read leads becomes proportionally larger compared to the distance between the read leads and the write lead. This factor, and the increased rate of change of the transmitted current can produce currents between the two read leads that are sufficiently large to damage the read stripe.

FIG. 1A is a graph illustrating cross-talk currents generated by a write current for the prior art embodiment. The upper graph indicates a write signal transmitted along the write lead 115. The write signal varies in magnitude between −40 mA and 40 mA with shifts of 80 mA over time periods of 1-5 nanoseconds. The lower graph indicates cross-talk generated between the first read lead and the second read lead in response to the sharp current shifts. The sharper peaks in the write signals generate cross-talk of roughly 500 microamperes.

### BRIEF DESCRIPTION OF THE DRAWINGS

FIG. 1 is block diagram illustrating a prior art embodiment of read and write wires.

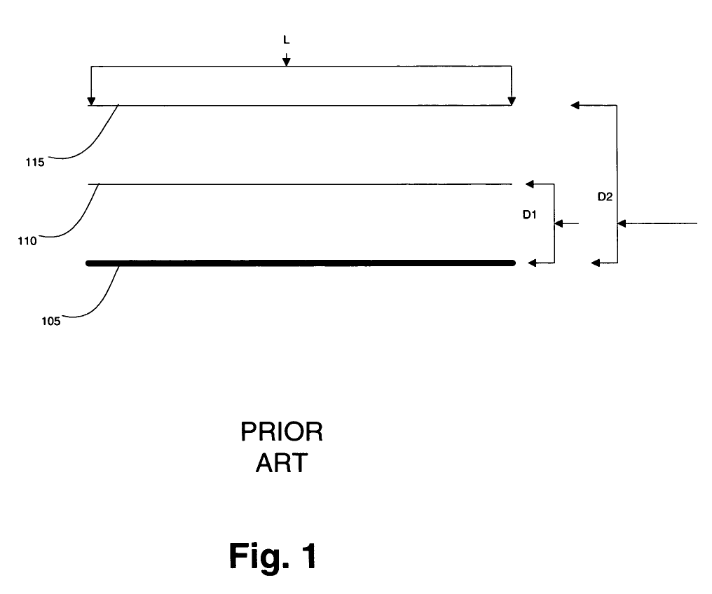

FIG. 1A is a graph illustrating cross-talk currents generated by a write current for the prior art embodiment.

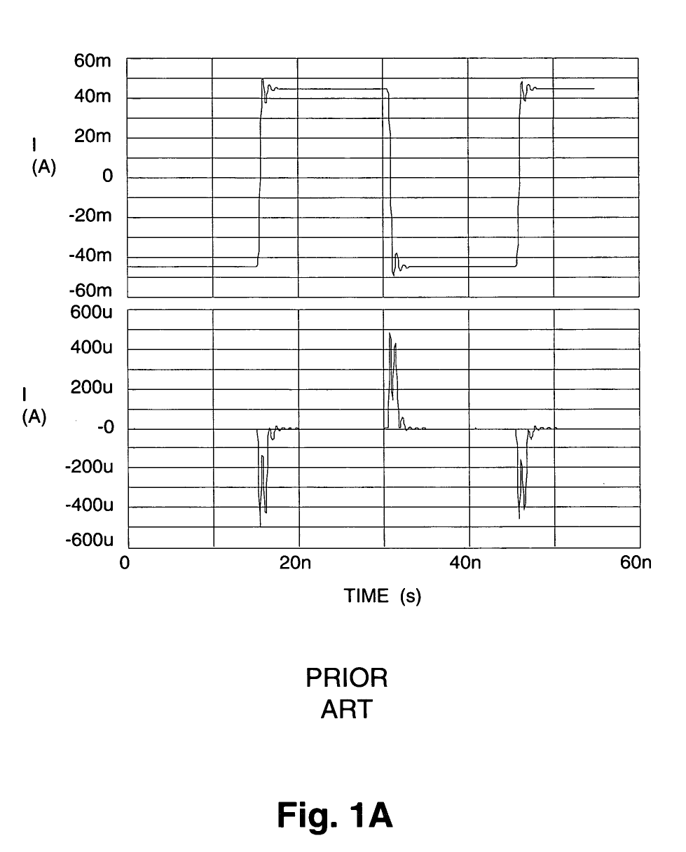

FIG. 2 is a block diagram illustrating a closer view of a hard drive.

FIG. 3 is a diagram illustrating a closer view of a storage medium of the hard drive

FIG. 4 is a block diagram illustrating a closer view of an actuator head.

FIG. 5 is a block diagram illustrating a closer view of crossed read wires and their interaction with a write wire.

FIG. 6 is a graph illustrating cross-talk currents generated by a write current for one embodiment of the present invention.

### DETAILED DESCRIPTION

Embodiments of the present invention relate to organizing a read stripe having multiple read leads such that a first read lead is closer to a write lead than a second read lead for part of their spans and the second read lead is closer to the write lead for another section of their spans.

A storage device is configured to read and write data from one or more storage media. The storage device includes an actuator which reads and writes data. The actuator includes two or more read leads that connect to a pre-amp and run parallel to a write lead. The read leads are configured such that they cross at the middle, thus mostly canceling out the differences in induced voltage between the two read leads and reducing cross-talk.

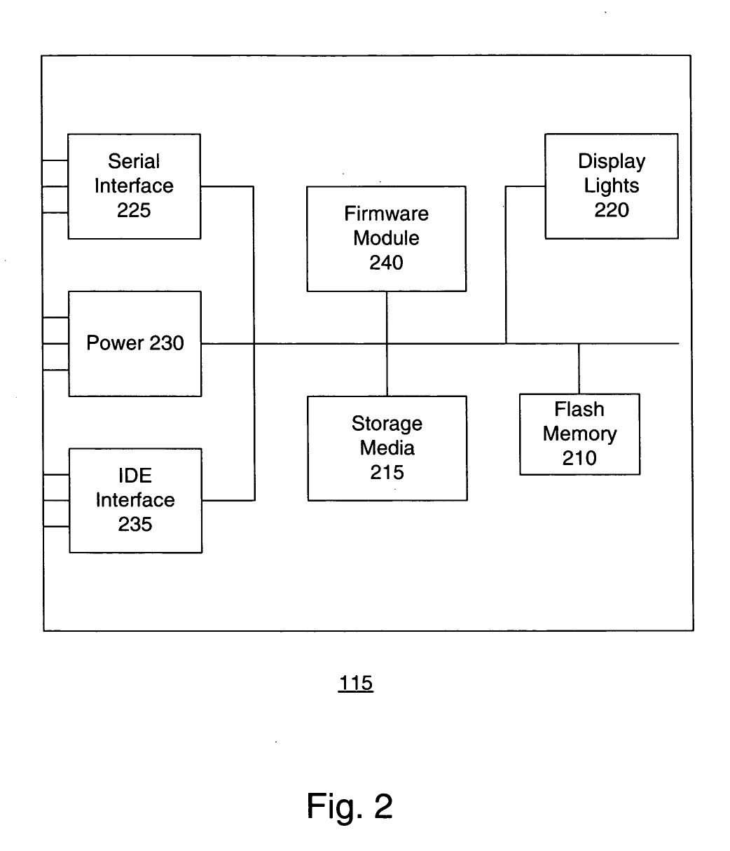

FIG. 2 is a block diagram illustrating an overview of a hard drive 115. In one embodiment, the hard drive 115 is a conventional hard drive that is used for storage in a personal computer or consumer electronics device. However in an alternate embodiment, the hard drive 115 is a proprietary storage device.

The hard drive 115 includes storage media 215. The storage media 215 comprise one or more solid state disks upon which the hard drive 115 writes data in the form of a magnetic imprint and from which it later reads back the data. Optical media drives may also be used within certain embodiments of the present invention.

The hard drive 115 also includes flash memory 210. The flash memory is a segment of non-volatile memory that is used for storage of instructions and other data. The flash memory 210 can be used to store output from test scripts. In one embodiment, the flash memory stores the Basic Input/Output System for the hard drive 115.

The firmware module 240 stores instructions managing the operation of the hard drive. In one embodiment, the firmware module 240 stores test and test management instructions for the hard drive 115. The firmware module can be included within the flash memory 210 or stored separately. The firmware module 240 can be configured to update itself upon the discovery of certain conditions or to receive external updates.

The hard drive 115 also includes display lights 220 that indicate the status of the hard drive. The display lights 220 indicate whether the hard drive is currently on, whether it is reading and/or writing, and whether it has completed its self-test correctly.

The hard drive 115 also includes a power connector 230. The power connector 230 draws power from the array 110 or the power supply of a host computer system.

Additionally, the hard drive 115 includes a serial connector 225. The serial connector 225 receives commands from the test computer through the array 110 and transmits test results to the test computer 105. The serial connector 225 may be a conventional RS-232 port, a Universal Serial Bus (USB) port or some manner of proprietary data connection.

The hard drive 115 also includes an Integrated Drive Electronics (IDE) interface 235. The IDE interface serves as the primary data interface between the hard drive 115 and a host system. The IDE connector may also be used for diagnostic purposes during testing.

While in the present embodiment the hard drive 105 relies upon an IDE interface to communicate, in an alternate embodiment, the hard drive is configured to access host machines through a Small Computer System Interface (SCSI) or a proprietary connection.

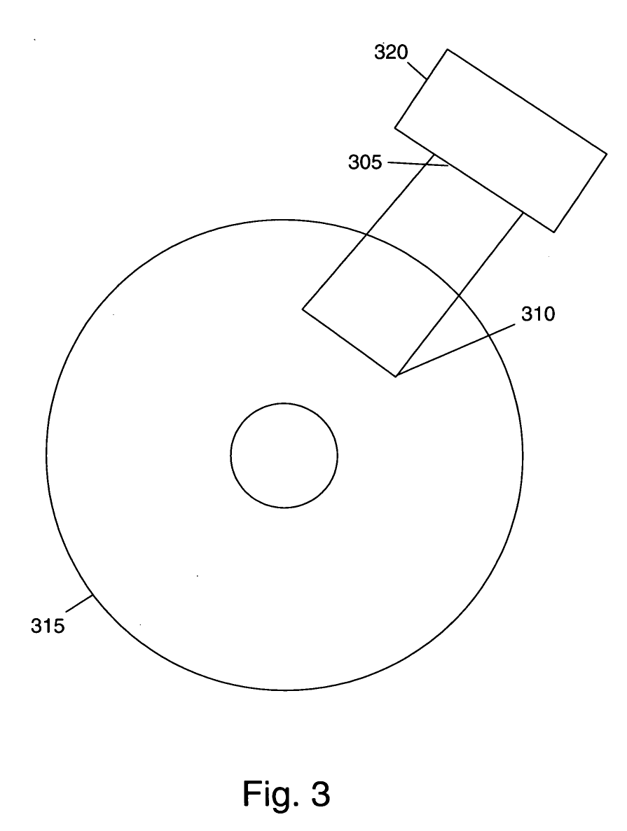

FIG. 3 is a block diagram illustrating a closer view of the storage media of the hard drive 110. The storage media include one or more circular plates 315 or disks upon which data is stored in the form of magnetic imprints. The hard drive 110 reads and writes data by moving an actuator 310 along the surface of the plates as the plates are spun. The tip of the actuator 310 includes write and read heads that respectively install and detect magnetic imprints on the surface of the plates 315.

A motor 320 controls the pressure with which the actuator heads 310 press against the surface of the plates and the speed with which the actuator moves across the surface of the plates 315 by adjusting the strength of the current used to move the actuator. These current adjustments are used to modify the performance of the hard drive.

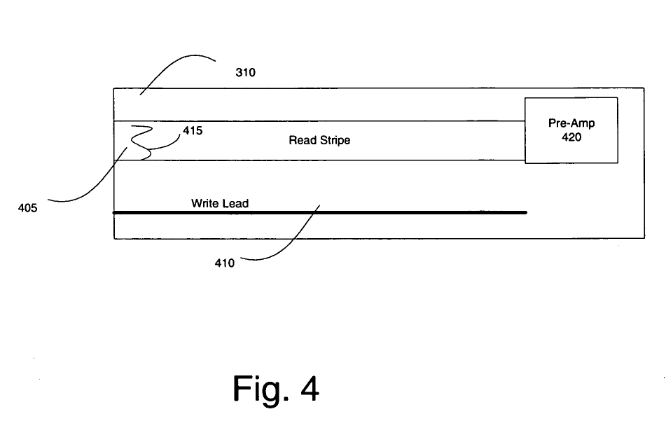

FIG. 4 is a block diagram illustrating a closer view of an actuator head. The actuator 310 is configured to receive and amplify signals generated by the reading of data and transmit them to the hard drive. The actuator 310 includes a read stripe 405, which contains two or more leads that are used to transmit signals to the pre-amp 420. The pre-amp is a series of circuits that amplify the read signal before transmitting it to a read channel.

The actuator includes a magnetoresistive sensor 415 on its read head which, when placed against a magnetic transition on the storage medium where data has been stored, generates a voltage. The voltage is transmitted along one or more read lines located within the read stripe 310 to the pre-amp 420.

A write lead 410 transmits signals to an inductor in the write head which imprints data on the surface of the storage medium. The signals transmitted along the write lead are typically considerably stronger than those transmitted along the read leads 405, 410.

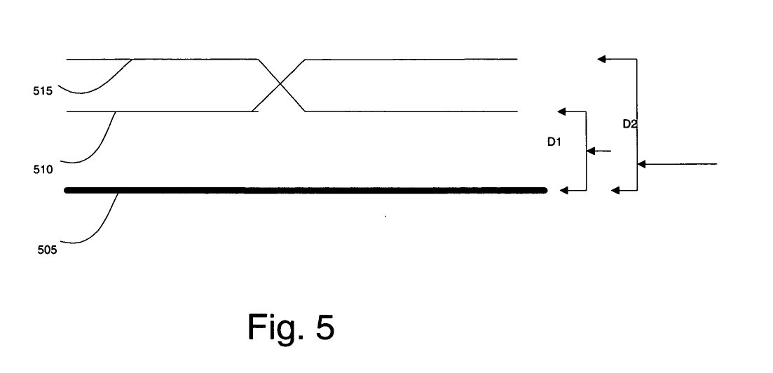

FIG. 5 is a block diagram illustrating a closer view of crossed read wires and their interaction with a write wire. While in the present embodiment, only two read leads are present on the read stripe, in an alternate embodiment, three or more read leads can be present. The first read lead 510 is located a distance D1 from the write lead for the first half of its span from its connection to the read head to the pre-amp. Approximately halfway across the span, the read leads cross and the first lead 510 is situated distance D2 from the write lead 505. Alternately the second read lead 515 is located a distance D2 from the write lead 505 for the first half of its span and is located distance D1 from the read lead for approximately the second half the span.

Since the write lead 505 is closer to the first read lead 510 for the first half of its span it induces a larger voltage in the first read lead for the first half of the span. In the region after the two leads cross, the write lead induces a larger voltage in the second read lead 515. Thus, the induced voltages in the first lead and second lead are roughly equivalent, resulting in reduced cross-talk between the two leads.

Note that while the term “cross” is used to discuss the relationship between the positions of the two read leads, there may be no physical contact between the two leads. As used herein, the crossing point refers only to a transition point along the length of the actuator between a section where the first read lead is closer to the write lead and a section where the second write lead is closer to the actuator.

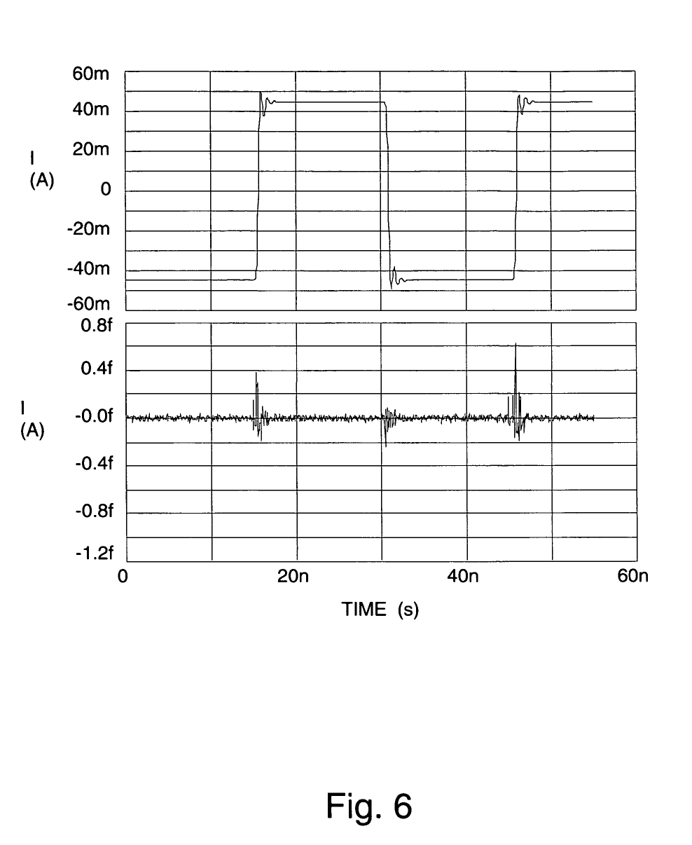

FIG. 6 is a graph illustrating cross-talk currents generated by a write current for one embodiment of the present invention. The upper graph indicates a write signal transmitted along the write lead 505. The write signal varies in magnitude between −40 mA and 40 mA with shifts of 80 mA over time periods of 1-5 nanoseconds. The lower graph indicates cross-talk generated between the first read lead and the second read lead in response to the sharp current shifts. The sharper peaks in the write signals generate cross-talk of roughly 0.4 femptoamperes.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

1. A read stripe within an actuator head of a storage device configured to collect read signals from the surface of a storage medium, the read stripe comprising:
a first read lead having a first section situated at a closer distance to a write wire and a second section situated at a farther distance to the write wire; and
a second read lead having a first section situated at the farther distance to the write wire and a second section situated at the closer distance to the write wire;
wherein the first read lead crosses the second read lead.

2. The read stripe of claim 1, wherein the first read lead crosses the second read lead at a location on the first read lead between the first section of the first read lead and the second section of the first read lead and a location on the second read lead between the first section of the second read lead and the second section of the second read lead.

3. The read stripe of claim 1, wherein the first section of the first read lead is configured parallel to the first section of the second read lead.

4. The read stripe of claim 1, wherein the second section of the first read lead is configured parallel to the second section of the second read lead.

5. The read stripe of claim 1, wherein the first section of the first read lead is equal in length to the first section of the second read lead.

6. The read stripe of claim 1, wherein the second section of the first read lead is equal in length to the second section of the second read lead.

7. The read stripe of claim 1, wherein a voltage induced by the write wire in the first section of the first read lead is approximately equal to a voltage induced by the write wire in the second section of the second read lead.

8. The read stripe of claim 1, wherein a voltage induced by the write wire in the second section of the first read lead is approximately equal to a voltage induced by the write wire in the first section of the second read lead.

9. The read stripe of claim 1, wherein a total voltage induced by the write wire in the first read lead is approximately equal to a total voltage induced by the write wire in the second read lead.

10. A storage device comprising:
a storage medium storing data; and
an actuator head configured to transmit read signals and write signals, the actuator head comprising:
a write wire; and
a first read lead having a first section situated at a closer distance to a write wire and a second section situated at a farther distance to the write wire; and
a second read lead having a first section situated at the farther distance to the write wire and a second section situated at the closer distance to the write wire;
wherein the first read lead crosses the second read lead.

11. The storage device of claim 10, wherein the first read lead crosses the second read lead at a location on the first read lead between the first section of the first read lead and the second section of the first read lead and a location on the second read lead between the first section of the second read lead and the second section of the second read lead.

12. The storage device of claim 10, wherein the first section of the first read lead is configured parallel to the first section of the second read lead.

13. The storage device of claim 10, wherein the second section of the first read lead is configured parallel to the second section of the second read lead.

14. The storage device of claim 10, wherein the first section of the first read lead is equal in length to the first section of the second read lead.

15. The storage device of claim 10, wherein the second section of the first read lead is equal in length to the second section of the second read lead.

16. The storage device of claim 10, wherein a voltage induced by the write wire in the first section of the first read lead is approximately equal to a voltage induced by the write wire in the second section of the second read lead.

17. The storage device of claim 10, wherein a voltage induced by the write wire in the second section of the first read lead is approximately equal to a voltage induced by the write wire in the first section of the second read lead.

18. The storage device of claim 10, wherein a total voltage induced by the write wire in the first read lead is approximately equal to a total voltage induced by the write wire in the second read lead.
